(19) United States
(12) Patent Application Publication
(10) Pub. No.: US 2012/0188495 A1
(43) Pub. Date: Jul. 26, 2012

(54) CHOLESTERIC LIQUID CRYSTAL DISPLAY DEVICE

(75) Inventors: Yu-hsien Chen, Kaohsiung City (TW); Sheng-fa Liu, Zhudong Township (TW); Ching-ho Li, Huatan Township (TW); Wei-jen Tu, Taipei City (TW); Huai-an Li, Zhongli City (TW); Shou-cheng Weng, Changhua City (TW)

(73) Assignee: CHUNGHWA PICTURE TUBES, LTD., Bade City (TW)

(21) Appl. No.: 13/083,525

(22) Filed: Apr. 8, 2011

(30) Foreign Application Priority Data
Jan. 21, 2011 (TW) 100102290

(51) Int. Cl. G02F 1/1335

(52) U.S. Cl. 349/115

(57) ABSTRACT

A cholesteric liquid crystal display device is disclosed. The cholesteric liquid crystal display device includes a substrate, a light absorbing layer, and a cholesteric liquid crystal layer. The cholesteric liquid crystal layer includes plural rows of left-handed cholesteric liquid crystals and plural rows of right-handed cholesteric liquid crystals which are arranged alternately. The left-handed cholesteric liquid crystals and the right-handed cholesteric liquid crystals respectively reflect left-handed light and right-handed light in the cholesteric liquid crystal display device of the present invention, whereby both eyes of an observer can see different images and thus a 3D effect is formed.

### BACKGROUND OF THE INVENTION

1. Field of the Invention

The present invention generally relates to a liquid crystal display device, and more particularly to a cholesteric liquid crystal display device which is capable of displaying a three-dimensional (3D) image.

2. Description of Prior Art

A spatial multiplexed method or a time multiplexed method is utilized in a 3D display device to allow a human's a left eye and a right eye to receive images from two different angles, respectively. Then, the images from the two different angles are merged as a depth perception image by a brain, thus forms a so-called 3D image.

Currently, a mainstream method used for observing the 3D image is by wearing special glasses. The method of wearing special glasses can be further categorized into a pattern retarder type and a shutter glasses type.

Please refer to FIG. 1, which illustrates a pattern retarder type 3D display device 10. In the pattern retarder type 3D display device 10, images from two different angles are provided for a left eye 100 and a right eye 102 by using a spatial multiplexed method. A 3D image is formed via the spatial multiplexed method by the left eye images 104 and the right eye images 106 which are respectively displayed by odd rows of pixels and even rows of pixels, and then the left eye 100 and the right eye 102 respectively observe the left eye images 104 and the right eye images 106 by using polarized glasses 108. However, the left eye images 104 and the right eye images 106 have to be processed in advance, and therefore a system loading of the pattern retarder type 3D display device 10 is increased.

Please refer to FIGS. 2A-2B, which illustrate a display principle of the shutter glasses type 3D display device. The time multiplexed method is utilized in the shutter glasses type 3D display device, whereby left eye images 204 and right eye images 206 are sequentially displayed, and then a left liquid crystal eyeglass 208 and a right liquid crystal eyeglass 210 of a synchronized shutter viewer 200 are controlled to be opened or closed by electronic signals. When the left eye images 204 are displayed, the left liquid crystal eyeglass 208 is opened and the right liquid crystal eyeglass 210 is closed, which is shown in FIG. 2A. In contrary, when the right eye images 206 are displayed, the right liquid crystal eyeglass 210 is opened and the left liquid crystal eyeglass 208 is closed, which is shown in FIG. 2B. The left eye images 204 and the right eye images 206 are sequentially and repeatedly displayed at a speed faster than a human vision persistence to form a 3D vision. In the shutter glasses type 3D display device, an advantage is that a resolution is not required to be decreased by one-half, however, a frame refresh frequency is required to be increased by at least twice, i.e. 120 hertz (Hz). Furthermore, when the frame refresh frequency is increased, liquid crystals are difficult to be converted to a required state and thus brightness is significantly decreased. In addition, the increasing frame refresh frequency can make an observer's sense of sight to be easily tired.

### SUMMARY OF THE INVENTION

An objective of the present invention is to provide a cholesteric liquid crystal display device which is capable of displaying a 3D image.

According to an aspect of the present invention, the cholesteric liquid crystal display device comprises a substrate, a light absorbing layer, and a cholesteric liquid crystal layer. The light absorbing layer is disposed on the substrate. The cholesteric liquid crystal layer is disposed on the light absorbing layer. The cholesteric liquid crystal layer comprises plural rows of left-handed cholesteric liquid crystals and plural rows of right-handed cholesteric liquid crystals which are arranged alternately.

According to another aspect of the present invention, the cholesteric liquid crystal display device comprises a substrate, a light absorbing layer, a first cholesteric liquid crystal layer, and a second cholesteric liquid crystal layer. The light absorbing layer is disposed on the substrate. The first cholesteric liquid crystal layer is disposed on the light absorbing layer. The second cholesteric liquid crystal layer is disposed on the first cholesteric liquid crystal layer. One of the first cholesteric liquid crystal layer and the second cholesteric liquid crystal layer comprises left-handed cholesteric liquid crystals, and the other one of the first cholesteric liquid crystal layer and the second cholesteric liquid crystal layer comprises right-handed cholesteric liquid crystals.

In the cholesteric liquid crystal display device of the present invention, the left-handed cholesteric liquid crystals and the right-handed cholesteric liquid crystals respectively reflect left-handed light and right-handed light, whereby both eyes of an observer may see different images and thus a 3D effect is formed.

### BRIEF DESCRIPTION OF THE DRAWINGS

FIG. 1 illustrates a pattern retarder type of 3D display device;

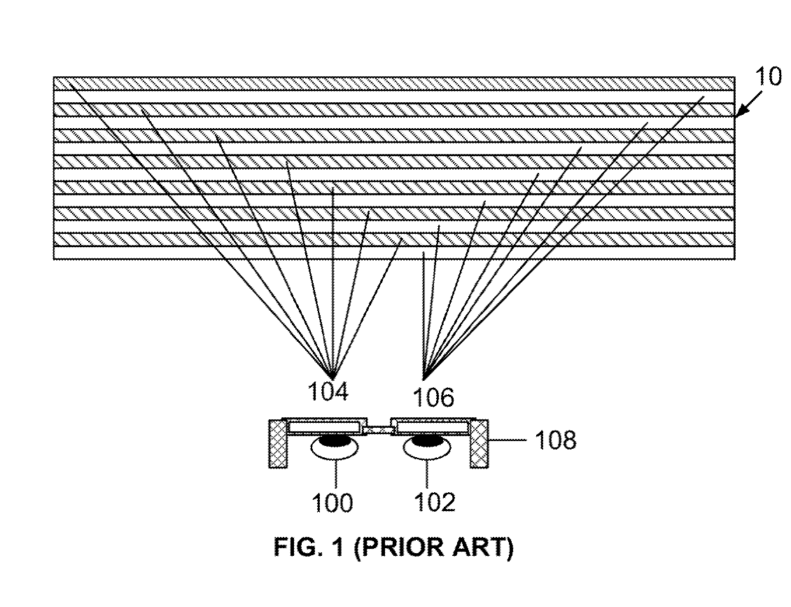

FIGS. 2A-2B illustrate a display principle of the shutter glasses type 3D display device;

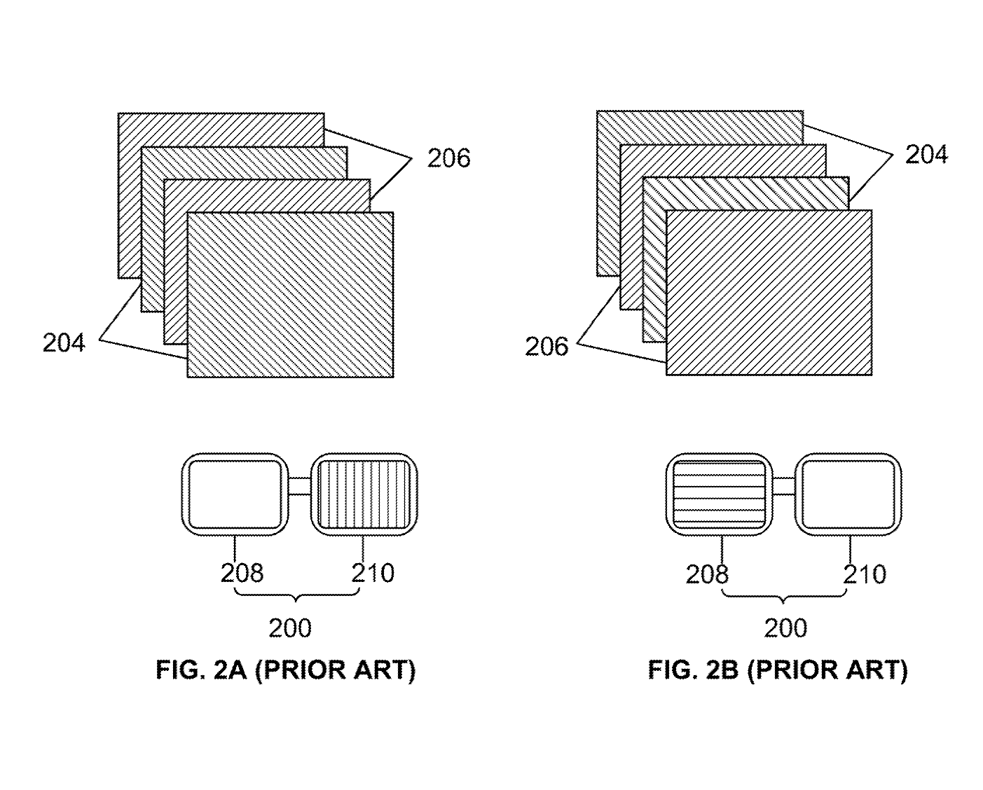

FIGS. 3A-3B illustrate a cholesteric liquid crystal display device and a display method of the cholesteric liquid crystal display device according to a first embodiment of the present invention;

FIGS. 4A-4B illustrate a cholesteric liquid crystal display device and a display method of the cholesteric liquid crystal display device according to a second embodiment of the present invention; and

FIGS. 5A-5B illustrate a cholesteric liquid crystal display device and a display method of the cholesteric liquid crystal display device according to a third embodiment of the present invention.

### DETAILED DESCRIPTION OF THE INVENTION

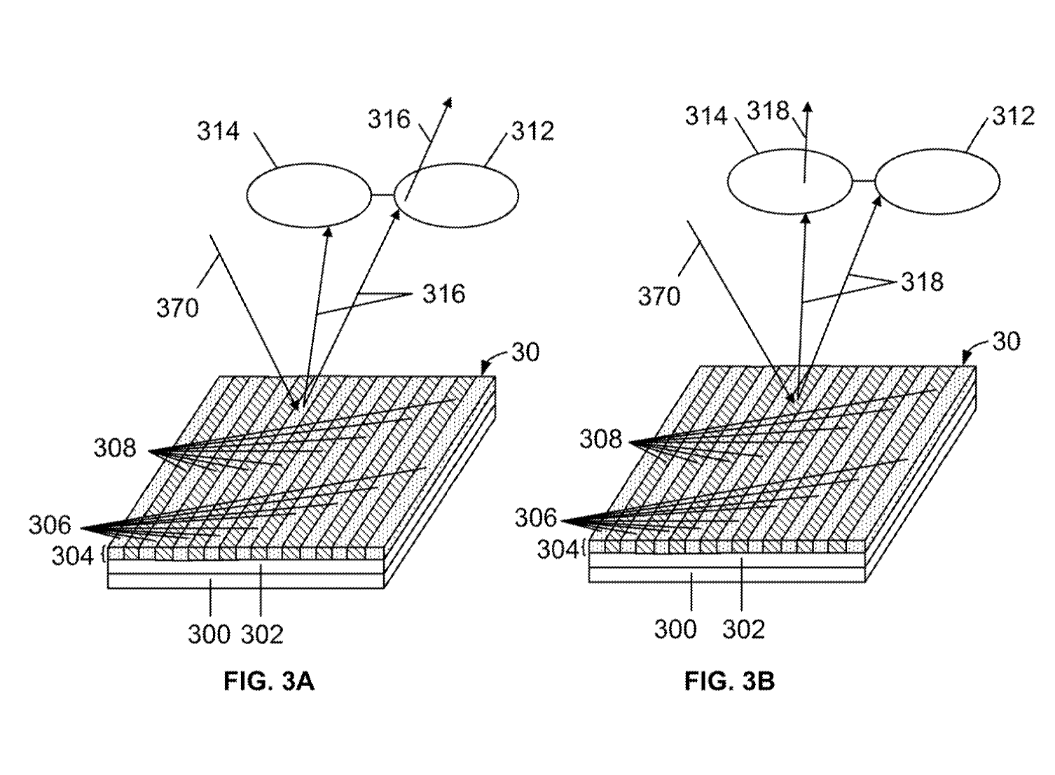

Please refer to FIGS. 3A-3B, which illustrate a cholesteric liquid crystal display device 30 and a display method of the cholesteric liquid crystal display device 30 according to a first embodiment of the present invention. The cholesteric liquid crystal display device 30 comprises a substrate 300, a light absorbing layer 302, and a cholesteric liquid crystal layer 304. The cholesteric liquid crystal display device 30 may be an active matrix display device or a passive matrix display device. The substrate 300 may be a glass substrate or a plastic substrate. The light absorbing layer 302 may be made of a black material or other materials which are capable of absorbing light. The light absorbing layer 302 is disposed on the substrate 300. The cholesteric liquid crystal layer 304 is disposed on the light absorbing layer 302. The cholesteric liquid crystal layer 304 comprises plural rows of red left-handed cholesteric liquid crystals 306 and plural rows of red right-handed cholesteric liquid crystals 308 which are arranged alternately. The cholesteric liquid crystal layer 304 is capable of reflecting light having a single wavelength in a range from 380 micrometer (μm) to 720 μm. For example, the red left-handed cholesteric liquid crystals 306 and the red right-handed cholesteric liquid crystals 308 may reflect red light of 620 μm. It is noted that a method for disposing the cholesteric liquid crystal layer 304 is understood by a person skilled in the art and thus is not described herein.

As shown in FIG. 3A, when an environmental light 370 comprising various colors of left-handed light and right-handed light enters the cholesteric liquid crystal display device 30, the red left-handed cholesteric liquid crystals 306 reflect only red left-handed light 316. Other colors of the left-handed and the right-handed light (not shown), as well as the red right-handed light (not shown) pass through the red left-handed cholesteric liquid crystals 306 and are absorbed by the light absorbing layer 302. When an observer (not shown) wears glasses including a left-handed polarizer 312 and a right-handed polarizer 314, the red left-handed light 316 which is reflected by the red left-handed cholesteric liquid crystals 306 may pass through the left-handed polarizer 312 and be absorbed by the right-handed polarizer 314. In another aspect, as shown in FIG. 3B, the red right-handed cholesteric liquid crystals 308 reflect only red right-handed light 318. The red left-handed light (not shown), as well as other colors of left-handed and right-handed light (not shown), pass through the red right-handed cholesteric liquid crystals 308 and are absorbed by the light absorbing layer 302. The red right-handed light 318 which is reflected by the red right-handed cholesteric liquid crystals 308 may pass through the right-handed polarizer 314 and be absorbed by the left-handed polarizer 312, whereby both eyes of the observer (not shown) may see different images and thus a 3D effect is formed.

In the present embodiment, the cholesteric liquid crystal display device 30 comprises the red left-handed cholesteric liquid crystals 306 and the right-handed cholesteric liquid crystals 308, and thus the cholesteric liquid crystal display device 30 is a 3D single color display device for displaying red images. In another embodiment, the cholesteric liquid crystal display device 30 may be a 3D single color display device for displaying only green images or blue images. A method for displaying 3D green images or 3D blue images is the same as in FIGS. 3A-3B and is not described herein.

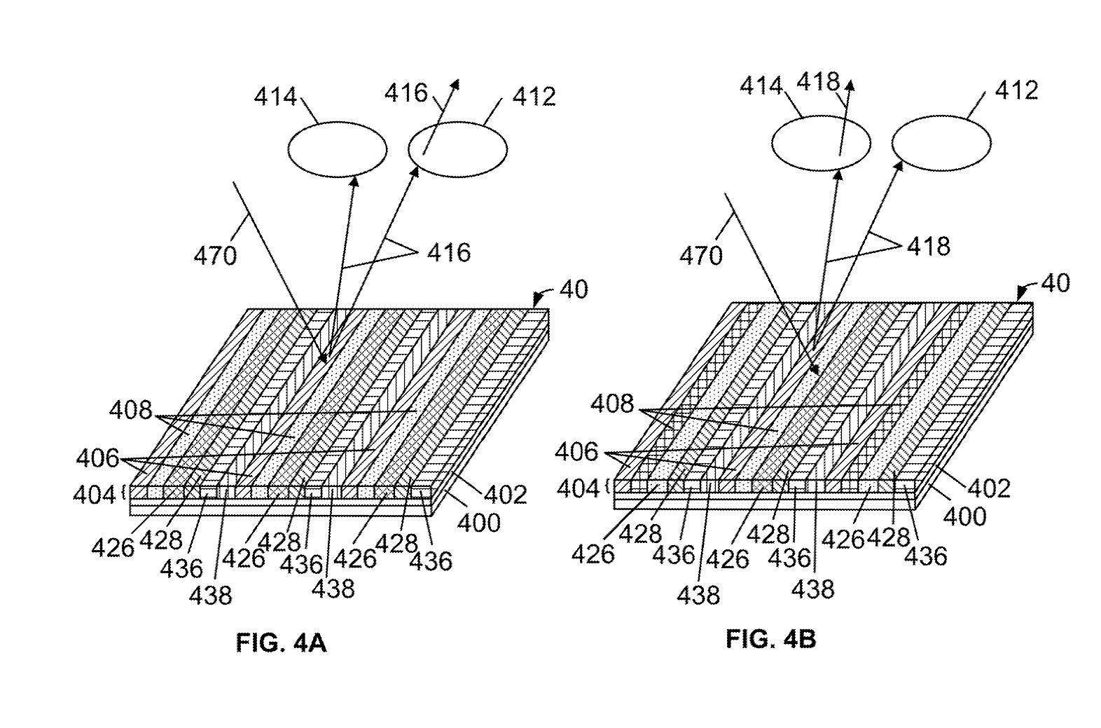

Please refer to FIGS. 4A-4B, which illustrate a cholesteric liquid crystal display device 40 and a display method of the cholesteric liquid crystal display device 40 according to a second embodiment of the present invention. The cholesteric liquid crystal display device 40 comprises a substrate 400, a light absorbing layer 402, and a cholesteric liquid crystal layer 404. The cholesteric liquid crystal display device 40 may be an active matrix display device or a passive matrix display device. The substrate 400 may be a glass substrate or a plastic substrate. The light absorbing layer 402 may be made of a black material or other materials which are capable of absorbing light. The light absorbing layer 402 is disposed on the substrate 400. The cholesteric liquid crystal layer 404 is disposed on the light absorbing layer 402. The cholesteric liquid crystal layer 404 comprises plural rows of red left-handed cholesteric liquid crystals 406, plural rows of red right-handed cholesteric liquid crystals 408, plural rows of green left-handed cholesteric liquid crystals 426, plural rows of green right-handed cholesteric liquid crystals 428, plural rows of blue left-handed cholesteric liquid crystals 436, plural rows of blue right-handed cholesteric liquid crystals 438 which are arranged alternately. The cholesteric liquid crystal display device 40 comprises the red, green, blue cholesteric liquid crystals, so 3D color images may be displayed. It is noted that a method for disposing the cholesteric liquid crystal layer 404 is understood by a person skilled in the art and thus not described herein.

In the present embodiment, a color sequence of the cholesteric liquid crystal layer 404 is red-green-blue. In another embodiment, the color sequence of the cholesteric liquid crystal layer 404 may be one selected from a group consisting of red-blue-green, green-red-blue, green-blue-red, blue-red-green, and blue-green-red.

As shown in FIG. 4A, when an environmental light 470 comprising various colors of left-handed light and right-handed light enters the cholesteric liquid crystal display device 40, the red left-handed cholesteric liquid crystals 406 reflect only red left-handed light. Other colors of left-handed and right-handed light (not shown), as well as the red right-handed light (not shown), pass through the red left-handed cholesteric liquid crystals 406 and are absorbed by the light absorbing layer 402. When an observer (not shown) wears glasses including a left-handed polarizer 412 and a right-handed polarizer 414, the red left-handed light 416 which is reflected by the red left-handed cholesteric liquid crystals 406 may pass through the left-handed polarizer 412 and be absorbed by the right-handed polarizer 414. In another aspect, as shown in FIG. 4B, the red right-handed cholesteric liquid crystals 408 reflect only red right-handed light 418. The red left-handed light (not shown), as well as the other colors of the left-handed and the right-handed light (not shown), pass through the red right-handed cholesteric liquid crystals 408 and are absorbed by the light absorbing layer 402. The red right-handed light 418 which is reflected by the red right-handed cholesteric liquid crystals 408 may pass through the right-handed polarizer 414 and be absorbed by the left-handed polarizer 412, whereby both eyes of the observer (not shown) may see different images and thus a 3D effect is formed. In a same manner, the green left-handed cholesteric liquid crystals 426 and the green right-handed cholesteric liquid crystals 428 respectively reflect green left-handed light and green right-handed light, and the blue left-handed cholesteric liquid crystals 436 and the blue right-handed cholesteric liquid crystals 438 respectively reflect blue left-handed light and blue right-handed light. A Method of the green or blue cholesteric liquid crystals for displaying 3D images are the same as that in FIGS. 4A-4B and not described herein.

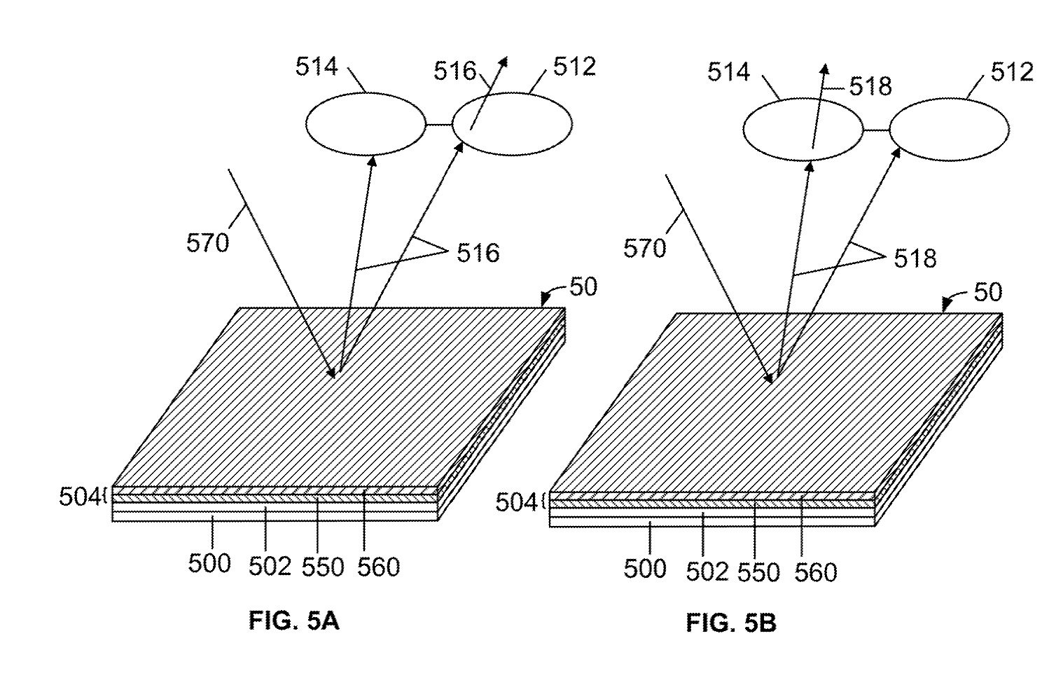

Please refer to FIGS. 5A-5B, which illustrate a cholesteric liquid crystal display device 50 and a display method of the cholesteric liquid crystal display device 50 according to a third embodiment of the present invention. The cholesteric liquid crystal display device 50 comprises a substrate 500, a light absorbing layer 502, a red left-handed cholesteric liquid crystal layer 550, and a red right-handed cholesteric liquid crystal layer 560. The cholesteric liquid crystal display device 50 may be an active matrix display device or a passive matrix display device. The substrate 500 may be a glass substrate or a plastic substrate. The light absorbing layer 502 may be made of a black material or other materials which are capable of absorbing light. The light absorbing layer 502 is disposed on the substrate 500. In the present embodiment, the red left-handed cholesteric liquid crystal layer 550 and the red right-handed cholesteric liquid crystal layer 560 are sequentially disposed on the light absorbing layer 502. In another embodiment, the red right-handed cholesteric liquid crystal layer 560 may be disposed on the light absorbing layer 502 firstly and then the red left-handed cholesteric liquid crystal layer 550 is disposed on the red right-handed cholesteric liquid crystal layer 560.

As shown in FIG. 5A, when an environmental light 570 comprising various colors of left-handed light and right-handed light enters the cholesteric liquid crystal display device 50, the red left-handed cholesteric liquid crystals 550 reflect only red left-handed light. Other colors of the left-handed and the right-handed light (not shown), as well as the red right-handed light (not shown), pass through the red left-handed cholesteric liquid crystals 550 and are absorbed by the light absorbing layer 502. When an observer (not shown) wears glasses including a left-handed polarizer 512 and a right-handed polarizer 514, the red left-handed light 516 which is reflected by the red left-handed cholesteric liquid crystals 550 may pass through the left-handed polarizer 512 and be absorbed by the right-handed polarizer 514. In another aspect, as shown in FIG. 5B, the red right-handed cholesteric liquid crystals 560 reflect only red right-handed light 518. The red left-handed light (not shown) and other colors of left-handed and right-handed light (not shown) pass through the red right-handed cholesteric liquid crystals 560 and are absorbed by the light absorbing layer 502. The red right-handed light 518 which is reflected by the red right-handed cholesteric liquid crystals 560 may pass through the right-handed polarizer 514 and be absorbed by the left-handed polarizer 512, whereby both eyes of the observer (not shown) may see different images and thus a 3D effect is formed.

In the present embodiment, the red left-handed cholesteric liquid crystal layer 550 and the red right-handed cholesteric liquid crystal layer 560 are disposed in a stack, and thus the cholesteric liquid crystal display device 50 is a 3D single color display device for displaying red images. In another embodiment, the cholesteric liquid crystal display device 50 may be a 3D single color display device including a green left-handed cholesteric liquid crystal layer and a green right-handed cholesteric liquid crystal layer in stack, or a 3D single color display device including a blue left-handed cholesteric liquid crystal layer and a blue right-handed cholesteric liquid crystal layer in stack. A method for displaying 3D green images or 3D blue images is the same as that in FIGS. 5A-5B and not described herein.

In conclusion, the left-handed cholesteric liquid crystals and the right-handed cholesteric liquid crystals of the present invention may be arranged alternately in the same layer (such as the first embodiment and the second embodiment), or may be disposed as two layers in stack (such as the third embodiment), whereby the left-handed cholesteric liquid crystals and the right-handed cholesteric liquid crystals respectively reflect the left-handed light and the right-handed light. Then, both eyes may see different images and thus a 3D effect is formed by wearing glasses including a left-handed polarizer and a right-handed polarizer.

Compared with the prior arts, the present invention comprises the following advantages. Firstly, it is not necessary for an image to be divided as a left eye image and a right eye image. Secondly, it is not necessary to increase a frame refresh frequency. Thirdly, the present invention may be implemented in current existing manufacturing processes, and an optical film is not required.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A cholesteric liquid crystal display device, comprising:
a substrate;
a light absorbing layer disposed on the substrate; and
a cholesteric liquid crystal layer disposed on the light absorbing layer, the cholesteric liquid crystal layer comprising plural rows of left-handed cholesteric liquid crystals and plural rows of right-handed cholesteric liquid crystals arranged alternately.

2. The cholesteric liquid crystal display device as claimed in claim 1, wherein the rows of the left-handed cholesteric liquid crystals and the rows of the right-handed cholesteric liquid crystals are the same color.

3. The cholesteric liquid crystal display device as claimed in claim 2, wherein the rows of the left-handed cholesteric liquid crystals and the rows of the right-handed cholesteric liquid crystals are red, green, or blue.

4. The cholesteric liquid crystal display device as claimed in claim 1, wherein the rows of the left-handed cholesteric liquid crystals are respectively arranged in a sequence of a first color, a second color, and a third color, and the rows of the right-handed cholesteric liquid crystals are arranged in a sequence of the first color, the second color, and the third color.

5. The cholesteric liquid crystal display device as claimed in claim 4, wherein the sequence of the first color, the second color, and the third color is selected from a group consisting of red-green-blue, red-blue-green, green-red-blue, green-blue-red, blue-red-green, and blue-green-red.

6. The cholesteric liquid crystal display device as claimed in claim 1, wherein the substrate is a glass substrate or a plastic substrate.

7. The cholesteric liquid crystal display device as claimed in claim 1, wherein the light absorbing layer is made of a black material.

8. The cholesteric liquid crystal display device as claimed in claim 1, wherein the cholesteric liquid crystal display device is an active matrix display device or a passive matrix display device.

9. A cholesteric liquid crystal display device, comprising:
a substrate;
a light absorbing layer disposed on the substrate;
a first cholesteric liquid crystal layer disposed on the light absorbing layer; and
a second cholesteric liquid crystal layer disposed on the first cholesteric liquid crystal layer, wherein one of the first cholesteric liquid crystal layer and the second cholesteric liquid crystal layer comprises left-handed cholesteric liquid crystals, and the other one of the first cholesteric liquid crystal layer and the second cholesteric liquid crystal layer comprises right-handed cholesteric liquid crystals.

10. The cholesteric liquid crystal display device as claimed in claim 9, wherein the first cholesteric liquid crystal layer and the second cholesteric liquid crystal layer are the same color.

11. The cholesteric liquid crystal display device as claimed in claim 10, wherein the first cholesteric liquid crystal layer and the second cholesteric liquid crystal layer are red, green, or blue.

12. The cholesteric liquid crystal display device as claimed in claim 9, wherein the substrate is a glass substrate or a plastic substrate.

13. The cholesteric liquid crystal display device as claimed in claim 9, wherein the light absorbing layer is made of a black material.

14. The cholesteric liquid crystal display device as claimed in claim 9, wherein the cholesteric liquid crystal display device is an active matrix display device or a passive matrix display device.
